(19) United States
(12) Patent Application Publication
(10) Pub. No.: US 2001/0054087 A1
(43) Pub. Date: Dec. 20, 2001

(54) Portable internet services

(76) Inventors: Michael Flom, Allendale, NJ (US); Joseph Polizzano, Glen Rock, NJ (US)

Correspondence Address: RICHARD F. JAWORSKI, Cooper & Dunham LLP, 1185 Avenue of the Americas, New York, NY, 10036, US

(21) Appl. No.: 09/843,512

(22) Filed: Apr. 25, 2001

Related U.S. Application Data
(60) Provisional application No. 60/199,690, filed on Apr. 26, 2000.

(51) Int. Cl. G06F 15/16

(52) U.S. Cl. 709/218; 709/227

(57) ABSTRACT

A content manufacturing and distribution system for manufacturing, distributing and caching content over wireless or wired Internet to portable devices. The system includes at least one portable device, the portable device capable of presenting users with portable device applications and content that are based on at least one of the user's community and personal preferences, the portable device including a cache for caching content packages on the portable device. A content manufacturing system processes information, data, and application objects from general external sources and community sources, and creates structured, searchable content packages relevant to at least one of a community, geography, and type of portable device. At least one internet server distributes the content packages over the wireless or wired Internet to portable devices based on at least one of community and user preferences. In response to a user submitting a request to the portable device application, the portable device cache is searched and used to fulfill the user request when relevant content packages are available in the portable device cache for fulfilling the request. User requests that require content not available in the portable device cache are routed to the at least one wired or wireless Internet server and content packages fulfilling the request are streamed down to the portable device, fulfilling the user request and updating the portable device cache so that subsequent user requests have access to the updated cache.

### REFERENCE TO RELATED APPLICATION

This application is based on and claims the benefit of provisional application Serial No. 60/199,690, filed Apr. 26, 2000, the entire contents of which are herein incorporated by reference.

### BACKGROUND

1. Field

The present disclosure relates to a system and method that creates customized web sites for portable electronic devices and provides portable Internet services.

2. Description of the Related Art

Huge demand is anticipated for mobile electronic commerce. However, unless a system can be provided that enables reliable and fast access to data, mobile users will not take advantage of the benefits provided thereby.

### SUMMARY

A content manufacturing and distribution system for manufacturing, distributing and caching content over wireless or wired Internet to portable devices. The system comprises at least one portable device, the portable device capable of presenting users with portable device applications and content that are based on at least one of the user's community and personal preferences, the portable device including a cache for caching content packages on the portable device. A content manufacturing system processes information, data, and application objects from general external sources and community sources, and creates structured, searchable content packages relevant to at least one of a community, geography, and type of portable device. At least one internet server distributes the content packages over the wireless or wired Internet to portable devices based on at least one of community and user preferences. In response to a user submitting a request to the portable device application, the portable device cache is searched and used to fulfill the user request when relevant content packages are available in the portable device cache for fulfilling the request. User requests that require content not available in the portable device cache are routed to the at least one wired or wireless Internet server and content packages fulfilling the request are streamed down to the portable device, fulfilling the user request and updating the portable device cache so that subsequent user requests have access to the updated cache.

Additional content that is anticipated to be required by the user of the portable device, determined by past behavior of the user, may be streamed to the portable device concurrent with subsequent user requests. The content packages may be streamed down to the portable device in background mode, permitting the portable device application to continue to serve content. As the portable device cache is updated with additional content, it may be made available to satisfy subsequent user requests, avoiding the need to route the request to the Internet servers. Based on at least one of user preferences, past user behavior, and the storage characteristics of the portable device, content in the portable device cache may be managed such that less frequently required content is deleted from the cache to free storage for other content. Each community may comprise a group of like end-users such as customers of a brand or special interest group. The user requests may include searches of content via name, address, category, geographic location, review criteria, schedules, directions, maps, bookings, reservations, and other criteria, in any combination. If the user requests require content not available in the portable device cache or on the at least one Internet server, the at least one Internet server may route a request to the content manufacturing system to create relevant content packages. In response to the request from the at least one Internet server, the content manufacturing system may then create one or more relevant content packages and route the relevant content packages via the Internet server, to the portable device for updating the portable device cache so that subsequent user requests have access to the updated cache.

A content manufacturing and distribution method for manufacturing, distributing and caching content over wireless or wired Internet to portable devices. The method comprises processing information, data, and application objects from general external sources and community sources, and creating structured, searchable content packages relevant to at least one of a community, geography, and type of portable device. The content packages are distributed over the wireless or wired Internet to portable devices based on at least one of community and user preferences, the portable device capable of presenting users with portable device applications and content that are based on at least one of the user's community and personal preferences, the portable device including a cache for caching the content packages on the portable device. In response to a user submitting a request to the portable device application, the portable device cache is searched to fulfill the user request when relevant content packages are available in the portable device cache for fulfilling the request. When user requests that require content not available in the portable device cache, the request is routed from the portable device to at least one wired or wireless Internet server. In response to the user request from the portable device, content packages fulfilling the request are streamed from the at least one wired or wireless Internet server down to the portable device fulfilling the user request. The portable device cache is updated with the content packages streamed down from the at least one wired or wireless Internet server so that subsequent user requests have access to the updated cache.

The method may further comprise streaming to the portable device concurrent with subsequent user requests, additional content that is anticipated to be required by the user of the portable device, determined by past behavior of the user. The method may comprise streaming content packages down to the portable device in background mode, permitting the portable device application to continue to serve content. As the portable device cache is updated with additional content, it may be made available to satisfy subsequent user requests, avoiding the need to route the request to the Internet servers. The content in the portable device cache may be managed such that less frequently required content is deleted from the cache to free storage for other content based on at least one of user preferences, past user behavior, and storage characteristics of the portable device. Each community may comprise a group of like end-users such as customers of a brand or special interest group. The user requests may include searches of content via name, address, category, geographic location, review criteria, schedules, directions, maps, bookings, reservations, and other criteria, in any combination. The method may further comprise routing a request from the at least one Internet server to the content manufacturing system to create relevant content packages if the user requests require content not available in the portable device cache or on the at least one Internet server. In response to the request from the at least one Internet server, the content manufacturing system may create one or more relevant content packages and route the relevant content packages via the Internet server, to the portable device for updating the portable device cache so that subsequent user requests have access to the updated cache.

A portable internet device capable of presenting users with portable device applications and content that are based on at least one of the user's community and personal preferences. The portable device comprises a cache for caching content packages, a user input for inputting commands and user requests for content to the portable internet device and an output for providing at least one of an audio and visual output to the user of the portable internet device. A control section searches the cache for relevant content packages in response to user requests. If relevant content packages are not available in the cache, the control section forwards a request to a remote server and content packages fulfilling the request are streamed down to the portable device from the remote server fulfilling the user request and stored in the portable device cache so that subsequent user requests have access to the updated cache.

An internet server for distributing content over at least one of a wired and wireless connection to portable internet devices. The internet server comprises a cache for storing content packages received from a content manufacturing system and a control section for receiving a request for content from the portable internet devices, the control section searching the cache for relevant content packages in response to the request from the portable internet device. If a relevant content package is available in the cache, the control section forwards the relevant content package to the portable internet device. If relevant content packages are not available in the cache, the control section forwards a request to a content manufacturing system requesting that relevant content packages be manufactured and returned to the internet server.

A method for creating customized, portable web sites comprises generating content packages including customized computer applications and data that integrate third party community, external, and personal information, data, and application objects and delivering the generated content packages to the portable electronic devices used by at least one of members of the community and members of related communities in response to user requests, wherein the content packages include at least one of community logo, menu choices, physical establishments, coupons, offers, advertisements, transactions, and other community-relevant content, name, address, category, geographic location, review criteria, schedules, directions, maps, bookings, reservations, transactions, and other content, in any combination.

A method for delivering and fulfilling offers provided to a portable device. The method comprises determining a location of a user of the portable device based on geo-specific information input by the user, the geo-specific information being location information supplied by the user or location information determined based on information included in the user's previous search requests and generating and delivering to the portable device a content package including offer information including nature of offer, validity dates of offer and establishments participating in the offer, wherein the content packages are delivered to users based on prior behavior, community membership, a manual search, a profile, or automatically based on location or any combination thereof and fulfilling the offer by presenting the offer to a merchant via at least one of screen display, transmission to a server and other method of communicating the offer to the establishment accepting the offer. In the event of a one-time offer, the establishment may confirm receipt and mark the offer fulfilled using manual entry on the portable device and/or a transmission to the portable device via at least one of wireless, wired, Bluetooth, infrared, voice input and similar method.

The offer presented to the merchant may include a bar code or code on a screen of the portable device which may be read or scanned by the merchant. The transmission to the server may be via at least one of wireless, wired, Bluetooth, infrared and, barcode on a screen of the portable device.

A method for contacting a call center. The method comprises presenting a user of a portable device with a form or menu for entering a call center request. The request may or may not be related to a special offer, advertisement, or coupon. In response to the request, contacting the call center to request a specific transaction, reservation, or information request. Providing a confirmation of the request to the user of the portable device.

A method for dynamically calculating and presenting directions on a portable electronic device, from a start point to at least one other point, using a single command. The method comprises determining at least one of a start point and the at least one other point based on actions of the user of the portable device, the actions of the user being for purposes other than for requesting directions and determining a route based on the determined start point and the at least one other point in response to a single command input by the user of the portable device and providing information concerning the route to the user of the portable device.

The information provided to the user of the device concerning the route may include at least one of a map and directions.

A method for gathering user comments on a portable device. The method comprises presenting the user of the portable device with at least one of a form and menu for entering comments and receiving from a user of the portable device comments related to a result of a search performed on a portable device that resulted in a location, point of interest, or establishment, and integrating the comments into content to be distributied to users of the portable devices.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is block diagram depicting an embodiment of a portable web site system;

FIG. 2 illustrates an exemplary customized portable web site;

FIG. 3 depicts an embodiment of an electronic offer system;

FIG. 4A illustrates an embodiment of an electronic offer system;

FIG. 4B illustrates a flowchart for describing operation of the electronic offer system;

FIG. 5 depicts an embodiment of a call center system;

FIG. 6 is a flowchart for describing the call center system;

FIG. 7 depicts an embodiment of a one-tap direction system;

FIG. 8 is a flowchart for describing the one-tap direction system;

FIG. 9 depicts an overall view of an embodiment of the portable Internet active cache technology.

### DETAILED DESCRIPTION

In describing preferred embodiments illustrated in the drawings, specific terminology is employed for sake of clarity. However, the present disclosure is not intended to be limited to the specific terminology so selected and it is to be understood that each specific element includes all technical equivalents which operate in a similar manner.

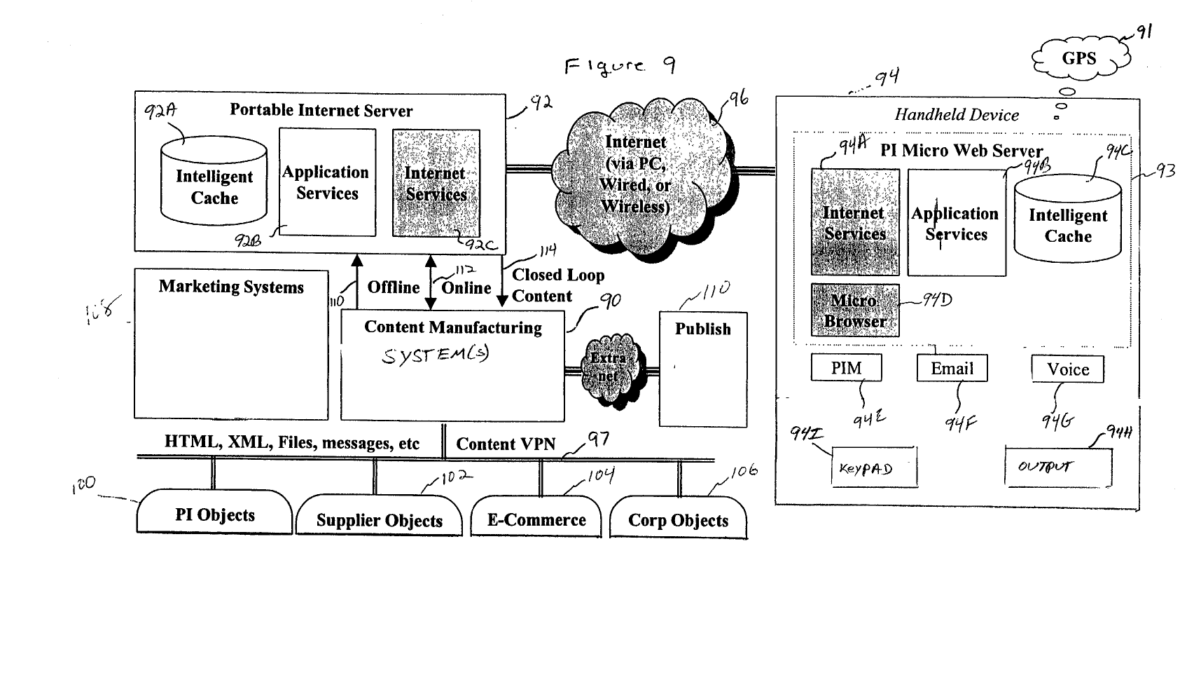

One aspect of the present specification relates to a system and method for manufacturing, distributing and caching content over wireless or wired Internet to portable devices. FIG. 9 depicts a system according to an embodiment. One or more Content Manufacturing Systems 90 process information, data, and application objects from general external sources, suppliers and community sources over a wired or wireless Internet connection. An example of a connection may be based on a content virtual private network (content VPN) using HTML, XML, files, messages, etc. for structuring content transfers. Content manufacturing systems 9 create structured, searchable content packages relevant to a community. Content manufacturing Systems 90 may then provide the content packages to one or more portable Internet servers 92 over a wired or wireless Internet connection for more volatile content (e.g., online or on-demand connection 112). The content packages may also be provided via offline or batch connection 110 for less volatile content via, for example, removable recording media. Content manufacturing systems 90 may also use closed loop content 114 from server 92 in the content packages as will be described later below. Portable Internet server(s) 92 may then distribute the content packages over wireless or wired Internet to portable devices 94 based on community and user preferences. External suppliers and communities may create their own content packages using automated or semi-automated facilities of the content manufacturing system.

Portable Internet servers 92 may include an intelligent cache 92A, application services 92B and Internet services 92C, as shown. These elements will be described in more detail below. Briefly, the cache 92A is a structured, searchable store of content packages. Cache 92A is updated as content packages are received from content manufacturing system 90. Application services 92B and Internet services 92C use information in cache 92A to fulfill user requests from portable devices 94.

Portable or handheld communication or computing devices 94 are capable of making search requests for accessing the content packages at portable Internet servers 92 via Internet 96. The communication between portable devices 94 and server(s) 92 can be via PC, wired or wireless access.

Each portable device 94 includes a portable Internet micro web server 93 resident on portable device 94. Micro web servers 93 may include Internet services 94A and micro browser software 94D used for accessing and browsing the Internet. Internet services 94A may include location sensitive streaming, sync management for synchronizing objects across servers, query management for managing request/responses across servers, transaction management for managing transaction-based request/fulfillment, security management for server access authentication, etc. Various application services 94B may also be provided, including personalization, map rendering, dynamic geocoding, geo search (location-based search), routing, alert management, tap-stream collection for collecting content and service requests made by users, and their sequences, PIM (personal information management) interchange for accessing address books, calendars, etc., email interchange for accessing email messages and addresses, E-wallet, application management, text-to-voice, voice-to-text, etc. An intelligent cache 94C may also be provided. Cache 94C stores content packages that may include markup language based documents such as HTML/XML/WAP/VML, binary executable or interpreted application objects, general content such as reviews and schedules and geo-coded objects that may include longitude/latitude information, etc. Output 94H which may be an audio and/or visual output device such as a speaker, display, etc. may be provided for outputting and/or displaying application screens and content to the user. As will be described below, the application screens and content displayed to the user may be based on each user's community and/or personal preferences. Each portable device 94 may also include PIM 94E, Email 94F providing capabilities for sending and receiving email, and voice control circuitry/software 94G for inputting commands and/or search requests to portable device 94. Portable device 94 may also include keypad 94I, allowing the user to manually input commands and/or search requests to the portable device. Keypad 94I may be implemented as a touch screen display type of device.

A user of Portable device 94 can input search requests and commands via keypad 94I and/or Voice recognition system 94G and Application services 94B, for example. The requests may include, but are not limited to, searches of content via name, address, category, geographic location, review criteria, schedules, directions, maps, bookings, reservations, and other criteria, or any combination thereof. Portable Internet servers 92 and micro web servers 93 on portable devices 94 cooperatively distribute content and services to fulfill user requests. As will be described later below, searchable content packages may be cached on the portable device 94 in intelligent cache 94C. The content packages may then be searched locally and used to fulfill user search requests when content packages including information relating to the search request are available in cache 94C. Search requests that require content that is not cached in cache 94C or elsewhere on portable device 94 may be routed to Internet service 94A and to portable Internet server 92 via wired or wireless Internet services 96. In response, portable Internet server 92 may then fulfill the request by streaming relevant content package(s) down to the portable device 94. These content packages can then be stored in portable device cache 94C. If relevant content packages are not present on server 92, server 92 can request content manufacturing system 90 to prepare relevant content packages. In response, content manufacturing system 90 will prepare the requested content packages and forward them to server 92 where they can be streamed down to portable device 94. Once a content package has been cached in cache 94C, subsequent user requests on portable device 94 will have local access to the updated cache information. This eliminates or minimizes the need to send requests to server 92 and download information each time a request is made.

Additional content that is anticipated to be required by the user of the portable device 94 can also be provided by server 92 and cached in cache 94C. For example, server 92 may be capable of running an application that can review a user's past searching behavior and, based thereon, anticipate future types of content requests the user might make. Content packages relating to the determined type of content can then also be streamed to the portable device 94 concurrent with subsequent user requests. In this manner, the information will be local on the portable device 94, if required in response to future requests.

Content exchange between server(s) 92 and portable device 94 may be bidirectional. Information input by users and collected at portable device 94 can uploaded to server(s) 92. For example, portable device users may be provided with a form, menu, etc. for entering comments about a location, service, etc. that they recently used or heard about. The comments can then remain on their portable device for future reference and/or be uploaded to server 92. This closed loop content 114 can then be sent to content manufacturing system 90 where it can be integrated into subsequent content packages which can then be distributed to other users.

The content package streaming from server 92 to portable device 94 can be performed in background mode, permitting the portable device application to continue to serve content even while cache 94C is being updated. As the portable device cache 94C is updated with additional content, it is made available to satisfy subsequent user requests, avoiding the need to route the request to the Internet servers 92.

Based on user preferences, past user behavior, and/or the storage characteristics of the portable device 94, content in the portable device cache 94C can be managed such that less frequently required content is deleted from the cache 94C to free storage for other content. In this way, the size of the cache 94C can be minimized.

Marketing systems 108 may use community personal preferences, collected tap-streams and other user-specific information for 1:1 marketing, tap-stream analysis, subscription management, royalty and commission reporting, online stores, wireless stores, etc. An external publishing system 110 may be connected to the content management system via a wired or wireless Internet link. The publishing system provides a way for third-party partners to deliver their content to the content manufacturing system so that it also can be incorporated into content packages.

Definitions of some of the terminology used herein will now be described. An information object as used herein refers generally to electronic data, computer programs, presentation language and/or transactions (collectively, “information”). Electronic data may include, but is not limited to, information in any electronic form, including binary, text, graphics, images, audio (including music and sound), or video format. Computer programs consist of computer code in source or binary format in any computer language. Presentation language is the general description of an end-user interface, which may be a display definition, and/or web pages in the form of HTML, DHTML, XML, VML, WML, HDML, VRML or other markup or presentation language or format. Transactions may be a query, message or update operation that operates synchronously or asynchronously with or without a result or confirmation.

The term Community as used herein may be, but is not limited to, a commercial or not-for profit corporation and its customers, a government organization and its citizens, an organization and its employees, contractors, or suppliers, a group or association and its members, the company offering a web site and its customers, a group of like end-users such as customers of a particular brand, etc., a special interest group and/or any grouping of individuals with shared interests. The phrase community information objects as used herein refers generally to, but is not limited to, information relevant to a given community. The phrase external information objects as used herein refers generally to, but is not limited to, information that is obtained outside the community from both licensed and generally available sources. The phrase personal information objects as used herein refers generally to, but is not limited to, information that is relevant to or created by an individual. The information objects are stored or contained on computer server(s) or in the case of certain personal information objects, in personal information files on portable electronic device 94, or on a users personal computer.

Examples of the types of information available to content manufacturing system 90 for creating content packages include portable Internet objects 100, supplier objects 102, E-commerce objects 104 and corporate objects 106. The information contained in the objects can be modified or changed with varying volatility. For example, portable Internet objects 100 may include low-volatility information such as geo data, directories, reviews, application objects, etc and medium-volatility information such as closed loop content, personal objects, E-offers, brand communities such as, for example, credit card companies and/or their members and vertical communities such as, for example, healthcare. Supplier objects 102 may include low-volatility information such as city guides, geo data, yellow pages, etc., medium-volatility information such as event schedules, email, news, weather, sports, etc. and high-volatility information such as traffic, quotes, etc. E-commerce information objects 104 may include high-volatility information such as reservations, ticketing, trading, auctions and purchases, etc. Corporate objects 106 may include medium-volatility information such as corporate e-mail, corporate PIM as well as high-volatility information such as transaction system information.

In the content manufacturing system 90, manufacture of information objects is governed by workflow rules that define transformation steps to produce content packages adapted to each community. The content packages may also be relevant to a particular geographic area and/or type of portable device. Workflow rules also govern the manufacturing process rate based on the volatility of the information objects. Geocoding is performed on location-based content. Transcoding is performed to adapt content to a portable device based on its storage, processing, and display characteristics. Compression is performed to reduce content storage requirements. Encryption is performed to ensure that only licensed users access the content. Packaging adds fast-access indices and creates a set of final content packages for a particular portable device platform, community, and geography.

As requests are received from a user of portable device 94, the micro web server 93 determines if the request can be fulfilled using content and services currently stored in the intelligent cache 94C on the portable device 94. If so, the request is fulfilled locally and a response returned to the user. User requests that require content or services that are not cached on the portable device 94 are routed to portable Internet servers 92. Responses are then streamed down from the servers 92 to the portable device 94, to both fulfill the user request as well as update the intelligent cache 94C on the portable device 92.

The following descriptions illustrate various implementations using the systems described above with respect to FIG. 9.

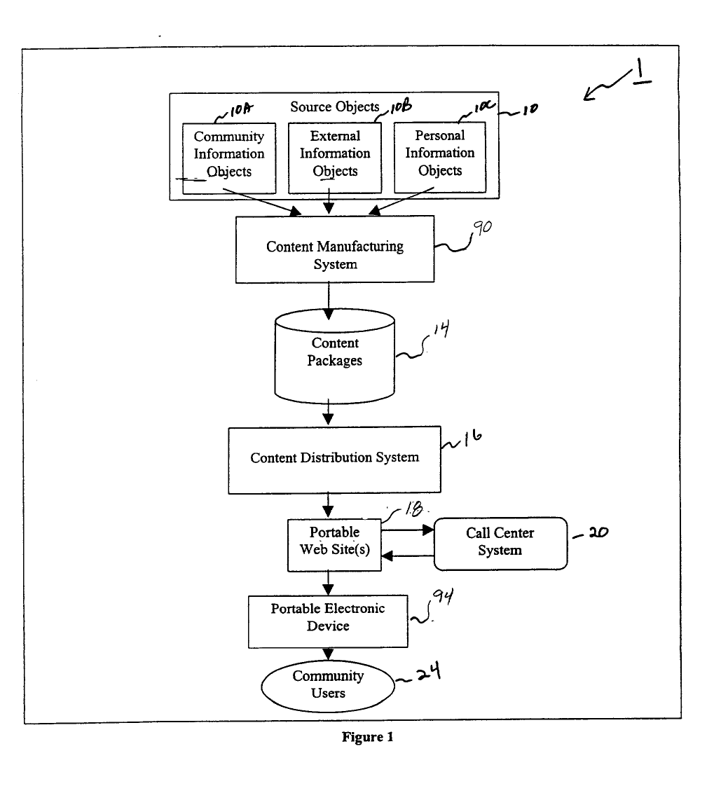

FIG. 1 illustrates a block diagram of an embodiment of a portable web site system, referred to generally as system 1.

As shown in FIG. 1, the information or objects available to the content manufacturing system 90 for creating content packages may further be categorized as community information objects 10A, external information objects 10B and personal information objects 10C and are collectively referred to herein as “source objects” 10. The content manufacturing system 90 processes the community information objects 10A, external information objects 10B, and/or personal information objects 10C in their native or source format.

Exemplary community information objects 10A include but are not limited to branded communities, vertical communities, the community of the company offering the portable web site and its members and may include closed loop content such as reviews and notes by community members that are introduced back into the content manufacturing system for wider community distribution. Community information objects 10A may also include corporate information such as corporate e-mail, corporate address books, corporate calendar/events, corporate database systems, and corporate transaction systems such as order entry systems.

Exemplary external information objects 10B include but are not limited to city guides, reviews, traffic reports, road construction reports, financial quotes (e.g. stocks), event schedules such as movies, sporting events and theater schedules, flight schedules, news, weather, sports, geo data such as street map data as well as alternative maps including rail routes and bus routes, topographical data, weather or population data, building plans, etc, yellow pages, white pages, reservation services, ticketing services, electronic offers, trading, auctions, purchases, alerts (e.g. flight delays).

Exemplary personal information objects 10C include but are not limited to e-mail, address books, calendars, itineraries, profiles or preferences, favorites and history.

Individual information objects 10 may appear in any or all of the object categories, depending on the characteristics of the community (e.g., a community may include electronic offers specific to that community).

The Content Manufacturing System 90 integrates into content packages information objects from one or more of the categories of source objects 10 relevant to a specific community, any number of which may be location sensitive (e.g., the information object may vary depending on the location of the user requesting the search.) Source objects 10 may change at any time and may be processed by content manufacturing system 90 in any order, in any combination, and in any subset. The content packages may include source objects 10 in any form. After a content package is formed, it may be stored on electronic computer media such as storage system 14, which may be a magnetic disk drive system.

The content manufacturing system 90 may be hosted on one or more computer server systems that may or may not be located at the same site as the storage system 14 that stores the content packages or the storage systems that store the information objects. These systems, if provided separately, may be linked electronically, via a computer network (such as leased, dial-up, wireless or wireline communications lines, or the Internet) or via storage media including but not limited to magnetic tape, diskette, removable disk, CD, DVD or other physical device or media for transferring information.

Content distribution system 16 physically (e.g., via disk) or electronically (e.g., via the Internet by wired or wireless modem) distributes content packages to portable web sites 18 for use by community users of portable electronic devices 94. Content distribution system 16 may consist of one or more of offline connection 110, online connection 112, closed loop content 114, PC, wired or wireless Internet connections, server 92 and/or micro browser 93 as described above with respect to FIG. 9. The content distribution system 16 may use methods such as user and community authentication, telephone or electronic order processing via the Internet, retail order processing, portable electronic device location, user selection, and/or other methods and systems to determine which user gets which content package. Content packages may be distributed in a batch, interactively, or a combination of batch and interactive (e.g., including a stream of data that may be dependent on the users location.)

Portable electronic device 94 is a mobile electronic device capable of communicating information under computer software program control. Such devices may include but are not limited to a handheld computer, laptop or notebook computer, vehicle computer, communicator (a handheld computer with voice capability), or a wireless phone with data communication capabilities. Information is distributed to the portable electronic device 94 via one or more of the following, including but not limited to: a wired or wireless Internet connection, or a storage medium like a CD, DVD, or storage card. Portable web site 18 has computer software program(s) (which may include computer programs delivered by the content package) which create web pages using one or more types of data in the content package, and which are communicated to and from the user via a user interface (for example, a visual display, audio speaker or headphone, and/or touch sensitive pad or display, buttons or wheels) on portable electronic device 94.

Portable web site 18 may exist on portable Internet server 92 which is in intermittent or constant communication with the portable electronic device 94 and/or, if the portable electronic device 94 has sufficient storage capabilities, on the portable electronic device itself. Content is distributed based on the community, and may be based on the user's preferences and/or the user's current location. Content manufacturing and distribution can be adjusted to accommodate for the user interface (e.g., display) characteristics provided on the portable device 94. For example, if one or more of the processing power, data storage capability, the communication capabilities, etc. of the portable electronic device 94 is not sufficient for providing particular content to the user, the content will not be downloaded to the portable device, thus saving valuable storage space on portable device 94. Content manufacturing and distribution may also be adjusted based on the nature of the end-user request (e.g., a query or a transaction which involves a small or large amount of volatile or non-volatile information.)

Portable web sites 18 provide a user interface on a portable electronic device 94 for finding relevant content and requesting application services such as search services for searching for information, routing (e.g., directions), map display as well as optionally requesting call center system 20 services such as reservations and ticketing. A community user 24 may optionally define or accept a profile that automatically performs application services on their behalf. For example, a user may define an interest in high quality French restaurants by performing repeated searches for this type of cuisine or by defining a profile that lists this interest.

The system 1 may be capable of keeping track of the location of community users 24 and of storing this information. The system can then choose and distribute content packages based on the user's location. For example, a portable device 94 may be provided with global positioning system (GPS) capabilities 91 as shown in FIG. 9, for periodically (automatically or in response to a user request) determining the location of the user of the device 94 and for storing location information. Portable server 92 may be provided with an application for periodically (automatically or in response to a user request) accessing the location information stored on portable device 94. Location information may also be determined by an application running on server 92 by examining any geo-specific search requests recently entered by the user of portable device 94. The application services 92B on server 92 may then automatically notify the user of a new or newly reviewed restaurant in their geographic area matching criteria previously input by the user or criteria determined by applications 92B running on server 92 based on previous search requests made by that user.

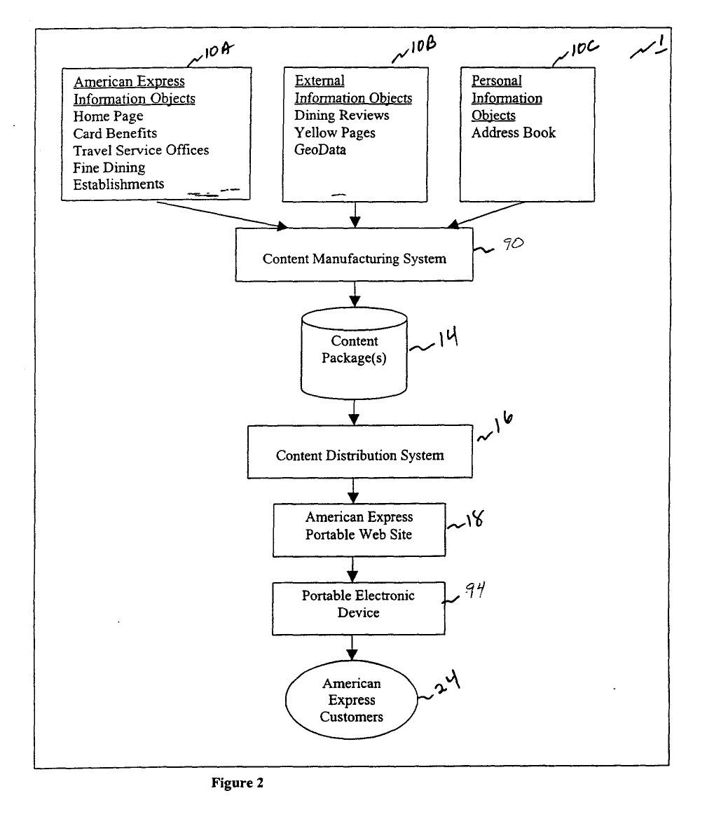

FIG. 2 illustrates an exemplary customized portable web site. In this example, American Express and its customers represent the community. Examples of the American Express information objects 10A which may be of relevance may include a customized home page with American Express logo and American Express menu options, a description of card member benefits, a database of American Express travel service offices, and a database of fine dining establishments.

Examples of external information objects 10B which may be of relevance include dining and lodging reviews, yellow page listings of business addresses and phone numbers, and geographic data consisting of street locations and addresses. An example of a personal information object 10C may include an electronic address book.

The content manufacturing system 90, content package storage 14 and content distribution system 16 operate as described above for creating and distributing community specific content packages consisting of one or more of the information objects 10A, 10B, 10C.

The portable web site 18 is customized via content that is relevant to the American Express community, for use by American Express customers. In this example, using a portable electronic device 94, American Express customers 24 may browse a card member benefits description, find nearby travel service offices, search descriptions of dining establishments by American Express as well as an external review provider, lookup an establishment's address and phone number, get directions to a selected establishment from an address in a personal address book, and display all locations of interest on a map.

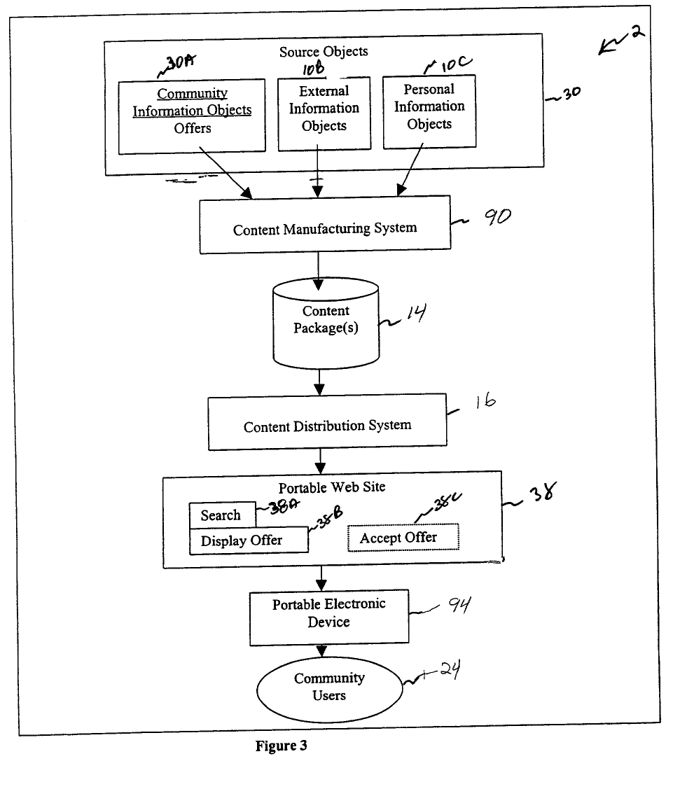

FIG. 3 depicts an embodiment of an electronic offer system referred to generally as system 2. The community information objects 30A may include, in addition to or separately from the information objects described above, offers targeted to a specific community. An offer may be a time-limited, good until revoked or perpetual discount, special availability (for example, allocated inventory or special hours available to offerees), a special price or current or future discount, or special feature (for example an upgrade to a better seat, view, gift with purchase). The content manufacturing system 90 is capable of processing these offers along with other information objects, and relating these offers to locations, establishments and services, for example, from other community information objects, external information objects 10B and personal information objects 10C to be included therewith in one or more content packages which are then stored in storage 14. Content distribution system 16 then distributes the content packages as described above.

The portable web site 38 search capabilities operate as described above with respect to portable web site 18. Additionally, if a search request 38A yields a relevant item with an associated offer, the offer is displayed to the user (38B) and the community user 24 is given the opportunity to accept 38C the offer or make an associated purchase via portable electronic device 94. Offers may be used to encourage community users to make specific establishment or service selections, allowing the offers to be easily targeted to specific class or classes of users. The offer can be fulfilled by the user by presenting it to a merchant via the user's portable device screen display. This may be presented in the form of a bar code or other type of code displayed on the screen of the portable device and capable of being read or scanned by the merchant. Another method of communicating the offer identification to the merchant may include transmitting it to a server accessible by the merchant. For one-time offers, the merchant may confirm receipt and mark the offer fulfilled by manually entry on the user's portable device and/or by transmission to the portable device via wired, wireless, Bluetooth, infrared, voice input or other method.

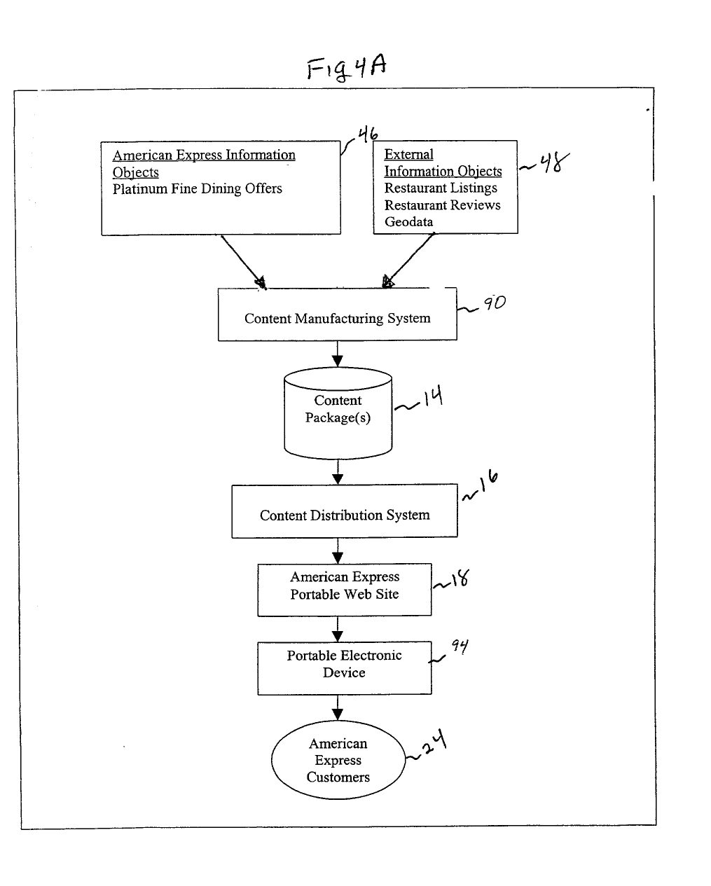

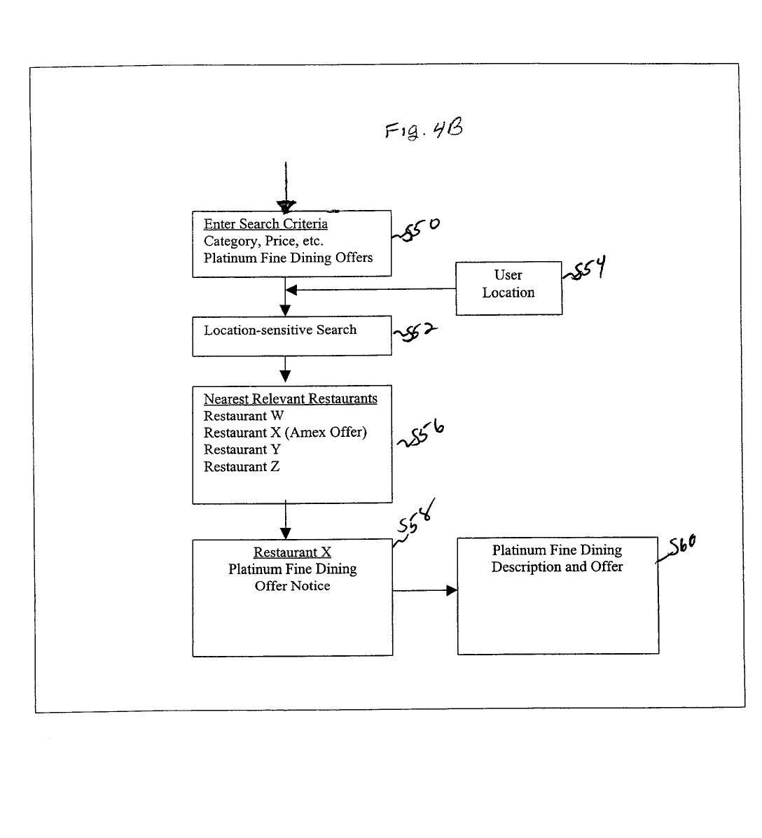

FIG. 4A depicts an exemplary electronic offer system and FIG. 4B is a flow chart for describing the system. In this example, American Express is the community, and examples of the American Express objects 46 which may be of relevance are a list and optional description of fine dining restaurants participating in a Platinum Card Fine Dining Offer program as shown in FIG. 4A. The Platinum Card Fine Dining Offer program may include special availability of tables for Platinum Card members. Examples of external objects 48 may include third party reviews of Platinum Card Fine Dining establishments, and geographic data consisting of restaurant locations in longitude and latitude format as well as street data required to construct a map on the user's portable device, allowing the user to easily locate a desired establishment. As described above, content manufacturing system 90 will create content packages specific to the American Express community and including these Platinum Fine Dining offers and related objects.

On portable device 94, an American Express Customer 24 may, as shown in FIG. 4B, request a search for restaurants by entering search criteria (Step S50) which may include cuisine category, average price, etc., and may select Platinum Fine Dining as a part of the relevant criteria. User location may also be determined (Step S54) by direct user input to portable device 94, by returning stored GPS data or by reviewing recent geo-specific search requests made by the user. The search criteria and location information can then be used to perform a location sensitive search (Step S52). Content distribution system 16 will then distribute relevant content packages. For example, returning to FIG. 9, the search can be performed locally on portable device 94 if relevant content packages have been previously stored in cache 94C. If relevant content packages are not present on portable device 94, portable device 94 will automatically forward the search request to server 92. If relevant content packages are present at server 92, they will be streamed down to portable device 94 and stored in cache 94C. If relevant content packages are not present at server 92, server 92 can request content manufacturing system 90 to create relevant content packages for distribution to the user of portable device 94. After the relevant content packages are found on or streamed down to portable device 94, the user is presented with a list of relevant and nearby restaurants (Step S56). Restaurants participating in the Platinum Fine Dining Program may be specifically identified as such in a search result listing (“Amex Offer”), as shown. After the user selects a desired restaurant (e.g., restaurant X) (Step S58), details of the offer and/or details, descriptions and reviews of the restaurant and/or directions to the restaurant may then be displayed to the user (Step S60). Members of the American Express community (and potentially others including prospective members) may thus easily view the details of the offer as well as information associated with the program or particular establishments participating in or in any way associated with the program. To exercise an offer at an establishment, the American Express Customer may be required to use an American Express or American Express Platinum Card.

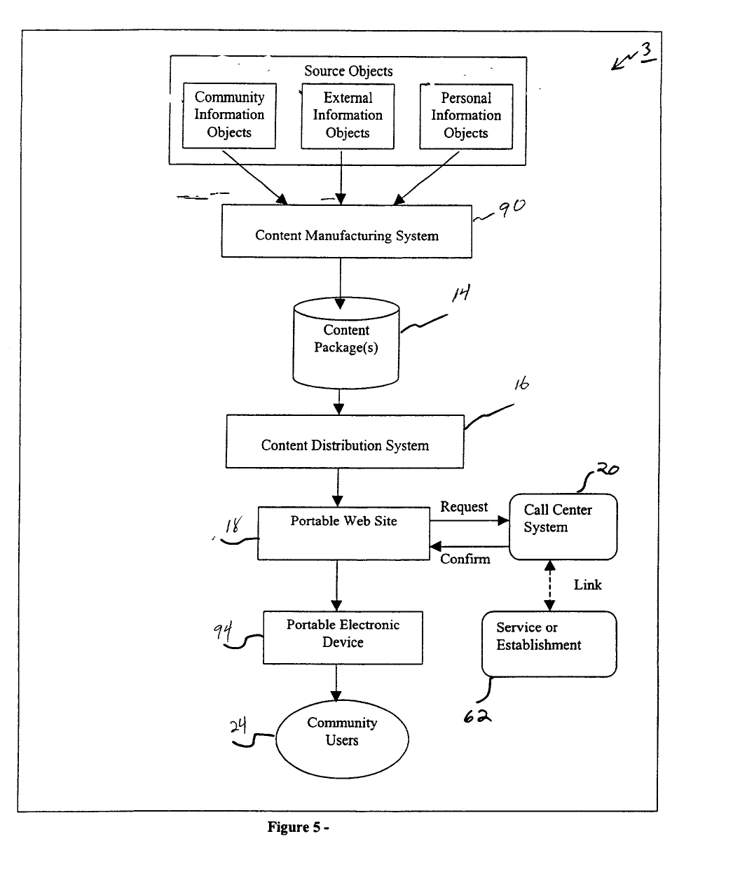

FIG. 5 depicts an embodiment of a call center system referred to generally as system 3. Source objects, the content manufacturing system 90, and the content distribution system 16 operate as described above. The portable web site 18 search capabilities also operate as described above. Additionally, a community user may electronically request a reservation or a transaction, for a given search result. The portable web site 18 processes the request and electronically transmits a message for fulfillment to another computer system or to a fulfillment organization. The fulfillment organization may be a call center 20 and the request/response between portable web site 18 and call center 20 may be via a wired or wireless connection. The decision to route the message to the call center 20 may be made by the portable web site 18 which as noted above, can be on either the Portable Electronic Device 94 or server 92. The call center system 20 receives the request and attempts to fulfill it via automated, semi-automated, or manual links to establishments 62, and sends the results of the call center service request back to the community user electronically or via a message, fax, voice or other communication.

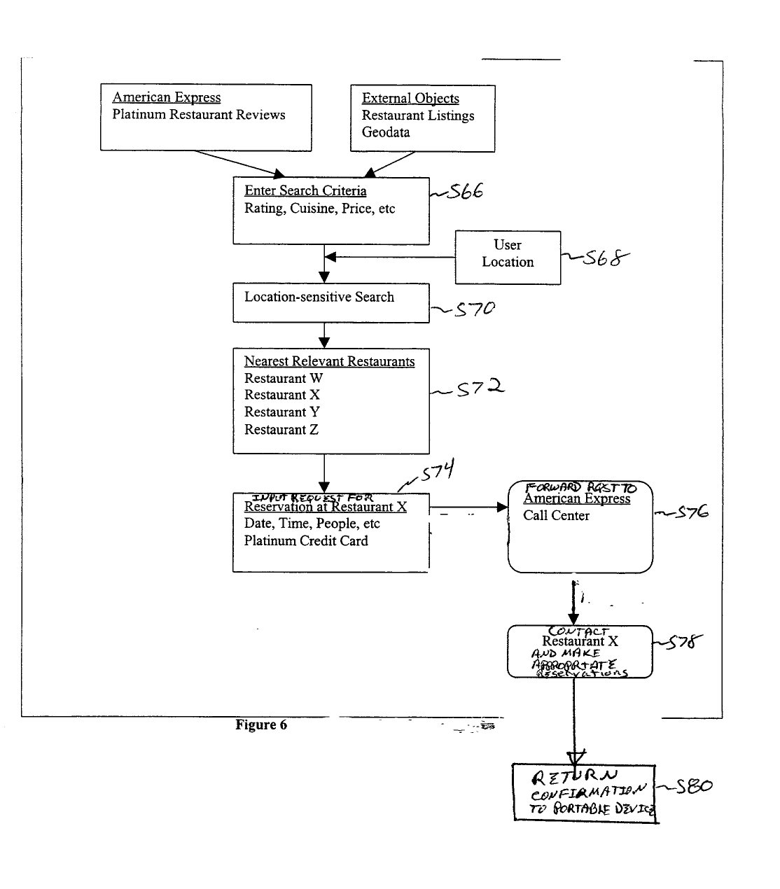

FIG. 6 illustrates a flow chart for describing an exemplary call center system flow. In this example, American Express Platinum Card is the Community. Examples of the American Express objects 62 which may be of relevance include a list of third party Platinum Restaurant reviews. Examples of external objects 64 may include restaurant listings and geographic data consisting of restaurant locations in longitude and latitude format as well as street data in a form for constructing a map on portable device 94. An American Express Platinum Card Customer may search for restaurants by entering criteria (Step S66) such as rating, cuisine category, average price, etc. User location information may also be provided (Step S68). For example, this information can be input by the user of portable device 94, can be determined from recent geo-specific search requests made by the user of portable device 94 or can be GPS information retrieved from portable device 94. A location sensitive search is then performed (Step S70). The search can retrieve information stored in portable device 94 and/or server 92, depending on the location of appropriate content packages. If content packages are not available, server 94 can request content manufacturing system 90 to prepare appropriate content package(s). The user is then presented with a list (Step S72) of relevant and/or nearby restaurants. The list can be output to a user 24 via output 94H on a display or an audio output, or a combination thereof. Once the appropriate content packages are located, American Express customers may then electronically request a reservation (Step S74) for a particular restaurant found in the list, or for any restaurant satisfying user-defined criteria by, for example, inputting the date, time and number of people for the desired reservation and the user's Platinum Credit Card details. The request is then forwarded to an American Express call center 20 (Step S76), or other direct communication system if available. The request might be wirelessly transmitted via email or other messaging system. The call center 20 then uses voice telephone lines or if appropriate, an electronic system to make the reservation with the desired restaurant (Step S78). A confirmation response may be sent back to the American Express Customer wirelessly to their portable device 94 via email or other messaging system (Step S80). To use this service, the American Express Customer may be required to use a Platinum Credit Card as payment.

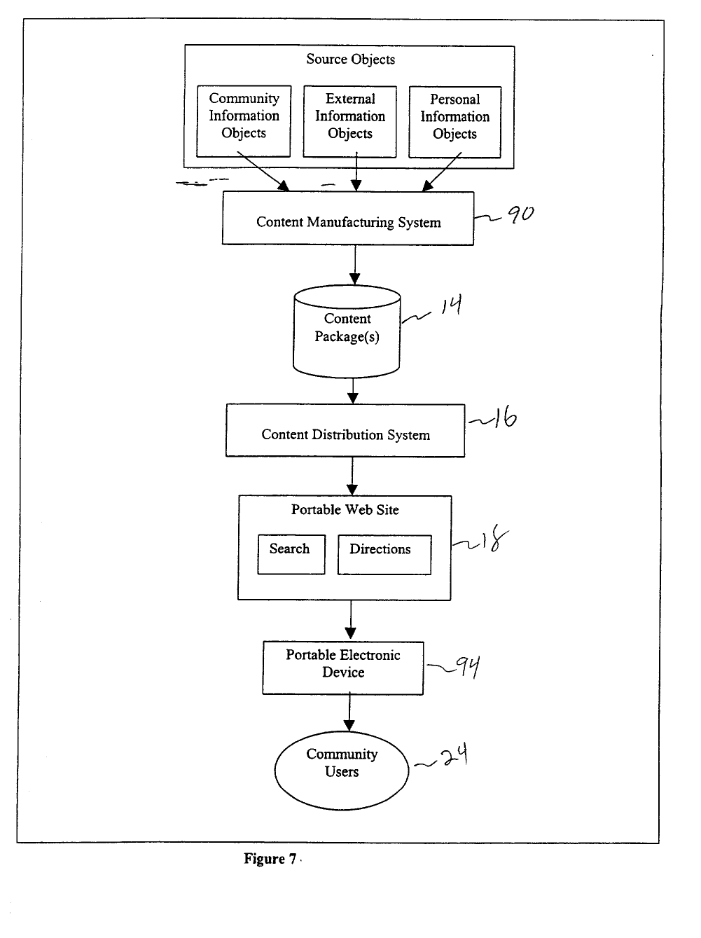

FIG. 7 depicts an embodiment of a one-tap direction system. Source objects, the content manufacturing system 90, and the content distribution system 16 operate as described above. The portable web site 18 search capabilities also operate as described above. Additionally, when a search yields a relevant item of interest, the community user may make a single request (e.g. tap one button) to get directions from their current location to the location of interest (the Destination). Optionally, the directions may be presented without any request by the end-user upon selection of the Destination. Directions may be presented in text, graphical (for example, a map), audio or other user interface formats. Directions may also be presented without any further action when the user selects a relevant item of interest. Directions may include walking, auto driving, truck driving, public transit or other modes of transportation or multi-modal directions that combine multiple modes of transportation.

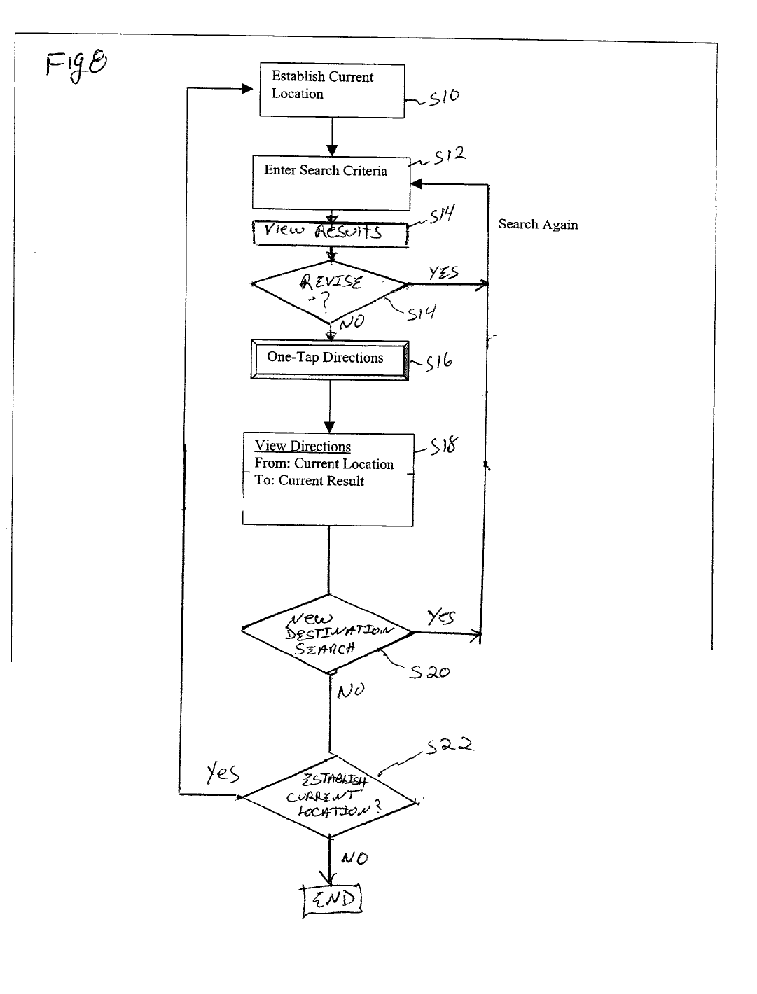

FIG. 8 is a flow chart for describing an exemplary one-tap direction method. First, the current location of the community user is established (Step S10) via any method including a previous search, Global Positioning System or other electronic positioning system signal, manual positioning operation, or default location established by the user or implied when a city or other destination is selected.

The user requests a search (Step S12), entering appropriate criteria. The search may specify an address, named place, and/or establishment satisfying one or more search criteria. When a search is complete, relevant results are presented (Step S14) based on the user community, user preferences, and/or user location. Search criteria may be revised and search requests repeated by a request from the user (Yes, Step S15) until a result of interest is found. If there is more than one result, the result of interest is selected by the user. If not, the sole result is deemed selected.

Once selected, directions from the current user location to the result of interest may be requested in Step S16 by tapping one button, saying a single voice command, or optionally made available at the time the result is selected by the user with no additional taps. Additional information entry such as starting or ending addresses is not required. That is, the result of a previous geo-specific search may be used to establish the starting location or GPS data may be automatically provided from the portable device so that the user is not required to input their current starting location. Establishing the current location at any step in the route, including the start and finish locations, may be performed by a single tap or command as well. Directions to the destination can be generated and presented to the user of portable device 94 (Step S18) as a step-by-step text, graphical or voice directions and/or shown as a route on a map. The starting or ending locations may also be identified in the directions. A determination is then made whether a new destination search is requested by the user. If a new destination is requested (Yes, Step S20), the process returns to Step S12. If No, Step S20, a determination is made whether the user has requested to reestablish their current location. If yes, Step S22, the process returns to Step S10. If No, Step S22, the process ends.

According to this embodiment, since the users previous location can be determined or remembered by the portable web site, based on stored GPS data and/or previous geo-specific search requests, and since the destination location may be automatically determined from the search criteria input by the user, the user's current location and their destination are easily determined without requiring the user to enter either the starting address or ending address. Directions to the destination can thus be easily and efficiently determined and communicated to the user of portable device 94 either automatically with the search results or by providing the user with a one click “ONE TAP DIRECTIONS” button on portable device 94.

The present embodiments may be conveniently implemented using one or more conventional general purpose digital computers and/or servers programmed according to the teachings of the present specification, as will be apparent to those skilled in the computer art. Appropriate software coding can readily be prepared by skilled programmers based on the teachings of the present disclosure, as will be apparent to skilled in the art. The present embodiments may also be implemented by the preparation of application specific integrated circuits or by interconnecting an appropriate network of conventional component circuits, as will be readily apparent to those skilled in the art.

Numerous additional modifications and variations of the present embodiments are possible in view of the above-teachings. It is therefore to be understood that within the scope of the appended claims, the present embodiments may be practiced other than as specifically described herein.

What is claimed is:

1. A content manufacturing and distribution system for manufacturing, distributing and caching content over wireless or wired Internet to portable devices, said system comprising:
at least one portable device, the portable device capable of presenting users with portable device applications and content that are based on at least one of the user's community and personal preferences, the portable device including a cache for caching content packages on the portable device;
a content manufacturing system that processes information, data, and application objects from general external sources and community sources, and creates structured, searchable content packages relevant to at least one of a community, geography, and type of portable device; and
at least one internet server that distributes the content packages over the wireless or wired Internet to portable devices based on at least one of community and user preferences,
wherein in response to a user submitting a request to the portable device application, the portable device cache is searched and used to fulfill the user request when relevant content packages are available in the portable device cache for fulfilling the request, and
wherein user requests that require content not available in the portable device cache are routed to the at least one wired or wireless Internet server and content packages fulfilling the request are streamed down to the portable device, fulfilling the user request and updating the portable device cache so that subsequent user requests have access to the updated cache.

2. A content manufacturing and distributing system as recited in claim 1, wherein additional content that is anticipated to be required by the user of the portable device, determined by at least one of location, past behavior of the user, user preferences and community preferences, is streamed to the portable device concurrent with subsequent user requests.

3. A content manufacturing and distributing system as recited in claim 1, wherein content packages are streamed down to the portable device in background mode, permitting the portable device application to continue to serve content.

4. A content manufacturing and distributing system as recited in claim 1, wherein as the portable device cache is updated with additional content, it is made available to satisfy subsequent user requests, avoiding the need to route the request to the Internet servers.

5. A content manufacturing and distributing system as recited in claim 1, wherein based on at least one of location, user preferences, community preferences, past user behavior, and the storage characteristics of the portable device, content in the portable device cache is managed such that less frequently required content is deleted from the cache to free storage for other content.

6. A content manufacturing and distributing system as recited in claim 1, wherein external suppliers and communities may create their own content packages using automated or semi-automated facilities of the content management system.

7. A content manufacturing and distributing system as recited in claim 1, wherein the user requests may include searches of content via name, address, category, geographic location, review criteria, schedules, directions, maps, bookings, reservations, and other criteria, in any combination.

8. A content manufacturing and distributing system as recited in claim 1, wherein if the user requests require content not available in the portable device cache or on the at least one Internet server, the at least one Internet server routes a request to the content manufacturing system to create relevant content packages.

9. A content manufacturing and distributing system as recited in claim 8, wherein in response to the request from the at least one Internet server, the content manufacturing system creates one or more relevant content packages and routes the relevant content packages via the Internet server, to the portable device for updating the portable device cache so that subsequent user requests have access to the updated cache.

10. A content manufacturing and distribution method for manufacturing, distributing and caching content over wireless or wired Internet to portable devices, said method comprising:
processing information, data, and application objects from general external sources and community sources, and creating structured, searchable content packages relevant to at least one of a community, geography, and type of portable device, wherein objects in a content package may be associated, using automated or semi-automated methods, with geographic location and content volatility; and
distributing the content packages over the wireless or wired Internet to portable devices based on at least one of community and user preferences, the portable device capable of presenting users with portable device applications and content that are based on at least one of the user's community and personal preferences, the portable device including a cache for caching the content packages on the portable device;
in response to a user submitting a request to the portable device application, searching the portable device cache to fulfill the user request when relevant content packages are available in the portable device cache for fulfilling the request;
when user requests that require content not available in the portable device cache, routing the request from the portable device to at least one wired or wireless Internet server;
in response to the user request from the portable device, streaming content packages fulfilling the request from the at least one wired or wireless Internet server down to the portable device fulfilling the user request; and
updating the portable device cache with the content packages streamed down from the at least one wired or wireless Internet server so that subsequent user requests have access to the updated cache.

11. A content manufacturing and distributing method as recited in claim 10, further comprising streaming to the portable device concurrent with subsequent user requests, additional content that is anticipated to be required by the user of the portable device, determined by at least one of location, past behavior of the user, user preferences and community preferences.

12. A content manufacturing and distributing method as recited in claim 10, further comprising streaming content packages down to the portable device in background mode, permitting the portable device application to continue to serve content.

13. A content manufacturing and distributing method as recited in claim 10, wherein as the portable device cache is updated with additional content, it is made available to satisfy subsequent user requests, avoiding the need to route the request to the Internet servers.

14. A content manufacturing and distributing method as recited in claim 10, further comprising managing content in the portable device cache such that less frequently required content is deleted from the cache to free storage for other content based on at least one of location, user preferences, past user behavior, community preferences and storage characteristics of the portable device.

15. A content manufacturing and distributing method as recited in claim 10, wherein external suppliers and communities may create their own content packages using automated or semi-automated facilities.

16. A content manufacturing and distributing method as recited in claim 10, wherein the user requests may include searches of content via name, address, category, geographic location, review criteria, schedules, directions, maps, bookings, reservations, and other criteria, in any combination.

17. A content manufacturing and distributing method as recited in claim 10, further comprising routing a request from the at least one Internet server to the content manufacturing system to create relevant content packages if the user requests require content not available in the portable device cache or on the at least one Internet server.

18. A content manufacturing and distributing method as recited in claim 17, wherein in response to the request from the at least one Internet server, the content manufacturing system creates one or more relevant content packages and routes the relevant content packages via the Internet server, to the portable device for updating the portable device cache so that subsequent user requests have access to the updated cache.

19. A portable internet device capable of presenting users with portable device applications and content that are based on at least one of the user's community and personal preferences, the portable device comprising:
a cache for caching content packages;
a user input for inputting commands and user requests for content to the portable internet device;
an output for providing at least one of an audio and visual output to the user of the portable internet device; and
a control section that searches the cache for relevant content packages in response to user requests, wherein if relevant content packages are not available in the cache, the control section forwards a request to a remote server and content packages fulfilling the request are streamed down to the portable device from the remote server fulfilling the user request and stored in the portable device cache so that subsequent user requests have access to the updated cache.

20. An internet server for distributing content over at least one of a wired and wireless connection to portable internet devices, said internet server comprising:
a cache for storing content packages received from a content manufacturing system;
a control section for receiving a request for content from the portable internet devices, the control section searching the cache for relevant content packages in response to the request from the portable internet device,
wherein if a relevant content package is available in the cache, the control section forwards the relevant content package to the portable internet device,
and wherein if relevant content packages are not available in the cache, the control section forwards a request to a content manufacturing system requesting that relevant content packages be manufactured and returned to the internet server.

21. A method for creating customized, portable web sites comprising:
generating content packages including customized computer applications and data that integrate third party community, external, and personal information, data, and application objects; and
delivering the generated content packages to the portable electronic devices used by at least one of members of the community and members of related communities in response to user requests,
wherein the content packages include at least one of community logo, menu choices, physical establishments, coupons, offers, advertisements, transactions, and other community-relevant content, name, address, category, geographic location, review criteria, schedules, directions, maps, bookings, reservations, transactions, and other content, in any combination.

22. A method for delivering and fulfilling offers provided to a portable device, said method comprising:
determining a location of a user of the portable device based on geo-specific information input by the user, the geo-specific information being location information supplied by the user or location information determined based on information included in the user's previous search requests;
generating and delivering to the portable device a content package including offer information including nature of offer, validity dates of offer and establishments participating in the offer, wherein the content packages are delivered to users based on prior behavior, community membership, a manual search, a profile, or automatically based on location or any combination thereof; and
fulfilling the offer by presenting the offer to a merchant via at least one of screen display, transmission to a server and other method of communicating the offer to the establishment accepting the offer,
wherein in the event of a one-time offer, the establishment may confirm receipt and mark the offer fulfilled using manual entry on the portable device and/or a transmission to the portable device via at least one of wireless, wired, Bluetooth, infrared, voice input and similar method.

23. A method as recited in claim 22, wherein the offer presented to the merchant includes a bar code or code on a screen of the portable device which may be read or scanned by the merchant.

24. A method as recited in claim 22, wherein the transmission to the server is via at least one of wireless, wired, Bluetooth, infrared and, barcode on a screen of the portable device.

25. A method for contacting a call center, said method comprising:
presenting a user of a portable device with a form or menu for entering a call center request, wherein said request may or may not be related to a special offer, advertisement, or coupon;
in response to the request, contacting the call center to request a specific transaction, reservation, or information request; and
providing a confirmation of the request to the user of the portable device.

26. A method for dynamically calculating and presenting directions on a portable electronic device, from a start point to at least one other point, using a single command, said method comprising:
determining at least one of a start point and the at least one other point based on actions of the user of the portable device, the actions of the user being for purposes other than for requesting directions;
determining a route based on the determined start point and the at least one other point in response to a single command input by the user of the portable device; and
providing information concerning the route to the user of the portable device.

27. A method as recited in claim 26, wherein the information provided to the user of the device concerning the route includes at least one of a map and directions.

28. A method for gathering user comments on a portable device, said method comprising:
presenting the user of the portable device with at least one of a form and menu for entering comments;
receiving from a user of the portable device comments related to a result of a search performed on a portable device that resulted in a location, point of interest, or establishment;
integrating the comments into content to be distributed to users of the portable devices.
